(19) United States
(12) Patent Application Publication
(10) Pub. No.: US 2026/0261817 A1
(43) Pub. Date: Sep. 3, 2026

(54) INFORMATION PROCESSING DEVICE, INFORMATION PROCESSING METHOD, AND COMPUTER PROGRAM

(71) Applicant: Sony Group Corporation, Tokyo (JP)

(72) Inventor: Akira TAKAHASHI, Saitama (JP)

(73) Assignee: Sony Group Corporation, Tokyo (JP)

(21) Appl. No.: 19/158,084

(22) PCT Filed: Feb. 2, 2024
(86) PCT No.: PCT/JP2024/003523

§ 371 Date: Aug. 20, 2025

(30) Foreign Application Priority Data
Mar. 31, 2023 (JP) 2023-057021

(51) Int. Cl. H04S 7/00; G10L 21/034; G11B 27/031; H04S 3/00

(52) U.S. Cl. CPC H04S 7/305; G10L 21/034; G11B 27/031; H04S 3/008; H04S 2400/01; H04S 2400/13

(57) ABSTRACT

An information processing device that automatically adds an effect such as reverberation similar to an effect in original content to a dubbed-in voice is provided.

The information processing device includes a reverberation extraction unit that receives an input of an acoustic signal, and separates and extracts a 1ch impulse response corresponding to a direct-wave component and an impulse response of a reverberation component. The reverberation extraction unit separates and extracts the respective impulse responses of the direct-wave component and the reverberation component from the acoustic signal, using a trained model that has been trained to estimate a 1ch impulse response corresponding to a direct-wave component and an impulse response of a surround signal corresponding to a reverberation component from a multi-channel acoustic signal.

### DESCRIPTION

### Technical Field

The technology disclosed in the present specification (hereinafter referred to as “the present disclosure”) relates to an information processing device that processes acoustic signals, an information processing method, and a computer program.

### Background Art

In multi-channel sound production for television programs, music, movies, and the like, a technique of adding reverberation is used to add a breadth and a realistic feeling to sound. For example, there is a proposed reverberation adding device that stores a reverberation model of each speaker obtained by emitting sound from one sound source, convolves the reverberation models with an acoustic signal to generate a reverberation component of each speaker, and reconstructs the reverberation component of each speaker in accordance with the angle formed by the sound source direction in the reverberation model and the sound source direction in the acoustic signal (see Patent Document 1).

Also, in the process of producing the foreign-language-dubbed version of movie content, it is strongly desired to add reverberation similar to that of the original content to the dubbed-in voices to add a breadth and a realistic feeling to the sound. In many cases, however, no files edited during the content production are present when the foreign-language-dubbed version is produced. In such a case, it is necessary to perform content editing such as adding reverberation to the dubbed-in voices by manual operations relying on the experience and intuition of the sound engineers, and the workload on them is very large.

As the number of channels increases due to the spread of surround systems, the editing work as described above becomes more complicated, and the time required for content production tends to become longer.

### CITATION LIST

### Patent Document

Patent Document 1: Japanese Patent Application Laid-Open No. 2014-45282

### SUMMARY OF THE INVENTION

### Problems to be Solved by the Invention

The present disclosure aims to provide an information processing device, an information processing method, and a computer program for processing acoustic signals during production of content such as movies.

### Solutions to Problems

The present disclosure has been made in view of the above problem, and a first aspect thereof is
an information processing device including a reverberation extraction unit that receives an input of an acoustic signal, and separates and extracts a 1ch impulse response corresponding to a direct-wave component and an impulse response of a reverberation component.

The reverberation extraction unit separates and extracts the respective impulse responses of the direct-wave component and the reverberation component from the acoustic signal, using a trained model that has been trained to estimate a 1ch impulse response corresponding to a direct-wave component and an impulse response of a surround signal corresponding to a reverberation component from a multi-channel acoustic signal.

The information processing device according to the first aspect further includes a rendering unit that mixes a dubbing voice signal corresponding to a voice signal included in the acoustic signal with the respective impulse responses of the direct-wave component and the reverberation component extracted by the reverberation extraction unit, to generate an acoustic signal of a dubbed version. During the mixing process, the rendering unit can apply time-varying panning information to the direct-wave component, or change the intensity and impression of reverberation by adding gain correction or a delay to the impulse response of the reverberation component.

Further, a second aspect of the present disclosure is
an information processing method including:
a reverberation extraction step of receiving an input of an acoustic signal, and separating and extracting a 1ch impulse response corresponding to a direct-wave component and an impulse response of a reverberation component; and
a rendering step of mixing a dubbing voice signal corresponding to a voice signal included in the acoustic signal with the respective impulse responses of the direct-wave component and the reverberation component extracted in the reverberation extraction step, to generate an acoustic signal of a dubbed version.

Further, a third aspect of the present disclosure is
a computer program written in a computer-readable format to cause a computer to function as:
a reverberation extraction unit that receives an input of an acoustic signal, and separates and extracts a 1ch impulse response corresponding to a direct-wave component and an impulse response of a reverberation component; and
a rendering unit that mixes a dubbing voice signal corresponding to a voice signal included in the acoustic signal with the respective impulse responses of the direct-wave component and the reverberation component extracted by the reverberation extraction unit, to generate an acoustic signal of a dubbed version.

The computer program according to the third aspect of the present disclosure is obtained by defining a computer program written in a computer-readable format to perform predetermined processing on a computer. The computer program can be provided for a computer capable of executing various program codes by a storage medium provided in a computer-readable form, a communication medium, a storage medium such as an optical disk, a magnetic disk, or a semiconductor memory, for example, or a communication medium such as a network. By installing the computer program according to the third aspect of the present disclosure in a computer via any of the media, a cooperative action is exerted on the computer, and operational effects similar to those of the information processing device according to the first aspect of the present disclosure can be achieved.

### Effects of the Invention

According to the present disclosure, it is possible to provide an information processing device, an information processing method, and a computer program for automatically adding an effect such as reverberation similar to an effect in the original content to a dubbed-in voice during production of a foreign-language-dubbed version of content such as a movie.

Note that the effects described in the present specification are merely an example, and the effects to be brought about by the present disclosure are not limited to them. Also, in some cases, the present disclosure may further provide additional effects in addition to the effects described above.

Still other objects, features, and advantages of the present disclosure will become apparent from a more detailed description based on embodiments as described later and the accompanying drawings.

### BRIEF DESCRIPTION OF DRAWINGS

FIG. 1 is a diagram illustrating a basic configuration of an information processing device 100 to which the present disclosure is applied.

FIG. 2 is a diagram illustrating an example configuration of an information processing device 100 that automatically adds an effect.

FIG. 3 is a diagram illustrating an example configuration of an information processing device 100 that performs automatic dubbing.

FIG. 4 is a diagram illustrating an example configuration of an information processing device 100 that extracts a reverberation style from a monophonic audio signal.

FIG. 5 is a diagram illustrating an example of a functional configuration for editing an effect to be added to acoustic signals during movie content creation.

FIG. 6 is a diagram illustrating an example configuration of send-return in a case where the number of sound sources is one.

FIG. 7 is a diagram illustrating an example configuration of send-return in a case where the number of sound sources is plural.

FIG. 8 is a chart showing an example of the waveform of a 5.1ch surround signal.

FIG. 9 is a diagram illustrating an example configuration of an information processing device 2000.

### MODE FOR CARRYING OUT THE INVENTION

In the description below, an embodiment of the present disclosure will be explained in the following order, with reference to the drawings.
A. Outline
B. Basic configuration
C. Embodiment
D. Example application (1)
E. Example application (2)
F. Example application to movie content creation
G. Input to DNN
H. Configuration of an information processing device

### A. Outline

In the process of producing a foreign-language-dubbed version of movie content, it is strongly desired to add reverberation similar to that of the original content to the dubbed-in voices to add a breadth and a realistic feeling to the sound. However, in a case where no files edited at the time of content product are present, it is necessary to perform content editing work such as adding reverberation to the dubbed-in voices by manual operations relying on the experience and intuition of the sound engineers, and the work becomes more complicated as the number of channels increases due to the spread of sound systems.

In view of this, the present disclosure proposes a technique for automatically adding an effect such as reverberation similar to an effect in the original content to a dubbed-in voice during production of a foreign-language-dubbed version of content such as a movie.

In the present disclosure, a reverberation style included in an acoustic signal is extracted, and the reverberation style is convolved into a foreign-language dubbed-in voice, so that an effect is automatically added to the dubbed-in voice. Specifically, in the present disclosure, a 1ch impulse response (without panning information) corresponding to a direct-wave component and an impulse response of a surround signal corresponding to a reverberation component are separated and extracted from a multi-channel surround acoustic signal of movie content or the like to be edited, and a process of combining (rendering) them with the foreign-language dubbed-in voice is performed. For example, it is possible to separate and extract the respective impulse responses of a direct-wave component and a reverberation component from a multi-channel acoustic signal, using a deep neural network (DNN) model that has been trained by deep learning so as to separate and extract a 1ch direct-wave component and a multi-channel reverberation component from a multi-channel surround acoustic signal.

In the present disclosure, it is possible to perform the following processes by separating the respective impulse responses of a direct-wave component and a reverberation component from an original multi-channel acoustic signal.
(1) During the mixing process in the subsequent stage, time-varying panning information can be applied to the direct-wave component.
(2) It is possible to change the intensity and impression of reverberation by adding gain correction or a delay to the impulse response of the reverberation component.

### B. Basic Configuration

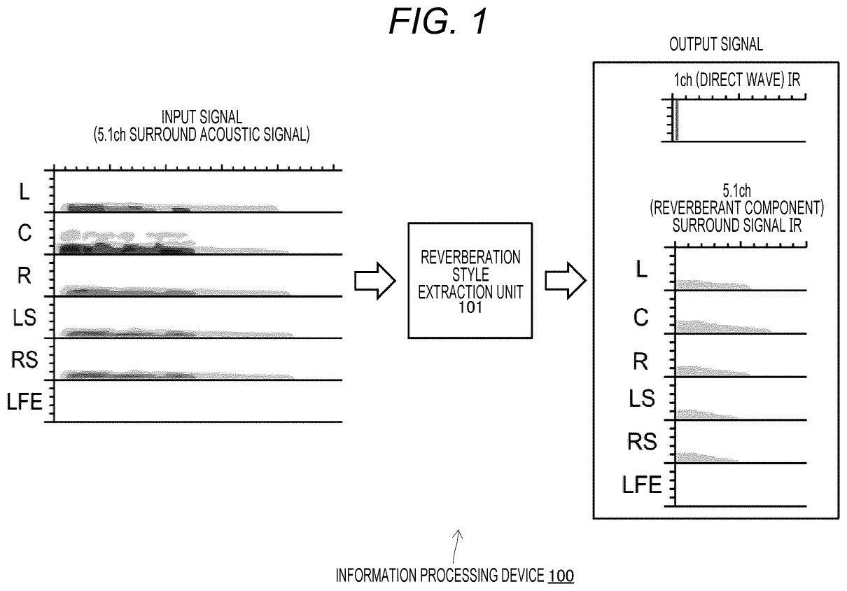

FIG. 1 shows a basic configuration of an information processing device 100 to which the present disclosure is applied, which is used in movie content production. The information processing device 100 can extract a reverberation style from a multi-channel acoustic signal, and is used for automatically adding reverberation and an effect to the dubbed-in voices in the process of producing a foreign-language-dubbed version.

The information processing device 100 illustrated in the drawing includes a reverberation style extraction unit 101. The reverberation style extraction unit 101 separates and extracts a 1ch impulse response (IR) (without panning information) corresponding to a direct-wave component and an impulse response (IR) of a surround signal corresponding to a reverberation component from a multi-channel surround acoustic signal.

Specifically, the reverberation style extraction unit 101 is formed with a DNN model that has been trained by deep learning so as to separate and extract a 1ch impulse response corresponding to a direct-wave component and an impulse response of a surround signal corresponding to a reverberation component from a multi-channel surround acoustic signal. Such a DNN can be trained using a data set including acoustic signals of enormous amounts of movie content in the past and acoustic signals of foreign-language-dubbed versions, for example. Also, it is possible to construct a data set using clean audio signals and impulse responses generated by an acoustic simulator.

Note that “surround” normally means that five or more speakers are installed so as to surround the viewer/listener and to create a sound field in which the viewer/listener is surrounded by sound. A surround multi-channel is denoted by the number of speakers and the number of subwoofers (speakers that exclusively reproduce ultra-low frequencies), which are connected by a dot. For example, a 5.1ch acoustic signal is formed with acoustic signals for six channels allocated to the respective speakers including L (the front speaker, left) and R (the front speaker, right) installed at equal distances to the left and right in front from the viewing position, C (the center) installed between L and R and mainly reproducing a speech sound signal clearly, 5ch for LS (the surround speaker, right) and RS (the surround speaker, left) installed at equal distances to the left and right from the viewing position, and 0.1ch for the subwoofer (low frequency effect (LFE)).

In the example illustrated in FIG. 1, the reverberation style extraction unit 101 separates and extracts a 1ch impulse response corresponding to a direct-wave component and a 5.1ch mixed impulse response corresponding to a reverberation component from these 5.1ch acoustic signals. The former 1ch impulse response includes an effect, an equalizer, and the like, but does not include panning information.

### C. Embodiment

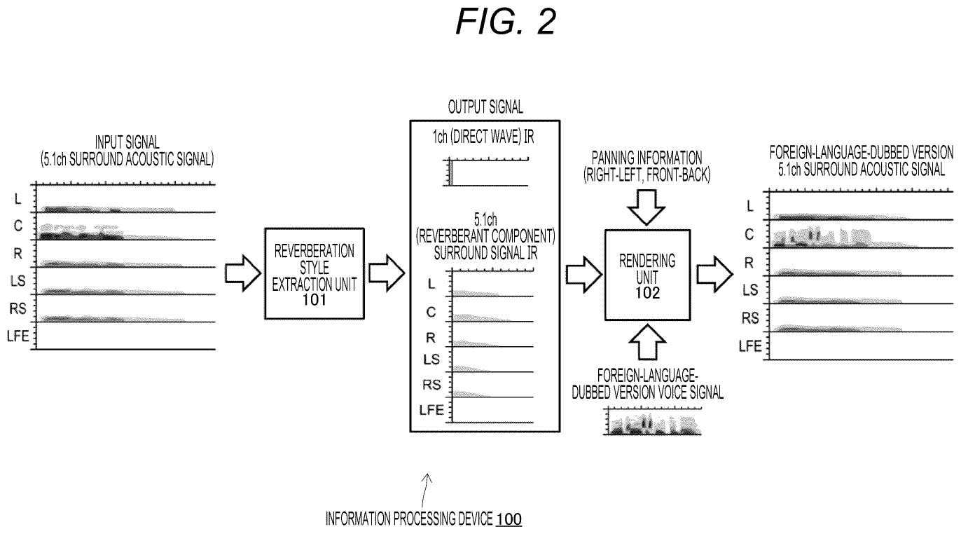

FIG. 2 illustrates an example configuration of the information processing device 100 that automatically adds an effect such as reverberation to a dubbed-in voice in a foreign language, using the basic configuration illustrated in FIG. 1 as the base. The information processing device 100 illustrated in the drawing includes a reverberation style extraction unit 101 and a rendering unit 102.

The reverberation style extraction unit 101 is formed with a DNN model (described above) trained by deep learning so as to separate and extract an impulse response (IR) of a 1ch direct-wave component and an impulse response (IR) of a multi-channel reverberation component from an original multi-channel surround acoustic signal, receives an input of a multi-channel surround acoustic signal such as an original sound source signal of movie content, and separates and extracts a 1ch impulse response (without panning information) corresponding to a direct-wave component and an impulse response of a surround signal corresponding to a reverberation component.

The rendering unit 102 mixes a Raw voice signal of a foreign-language-dubbed version with the 1ch impulse response (IR) (without panning information) corresponding to the direct-wave component and the impulse response (IR) of the surround signal corresponding to the reverberation component extracted from the original surround acoustic signal by the reverberation style extraction unit 101, and thus, generates a multi-channel (5.1ch) surround acoustic signal of a foreign-language-dubbed version.

With the information processing device 100 illustrated in FIG. 2, an effect such as reverberation can be estimated from the original multi-channel surround acoustic signal, and be added to a multi-channel surround acoustic signal of a foreign-language-dubbed version. That is, with the information processing device 100 illustrated in FIG. 2, it is possible to automate the effect addition to acoustic signals of a foreign-language-dubbed version, which has been manually performed by sound engineers, and a large increase in work efficiency is expected.

With the information processing device 100 illustrated in FIG. 2, the reverberation style extraction unit 101 uses the result of separating the respective impulse responses of the direct-wave component and the reverberation component from the original surround acoustic signal, and thus, it is possible for the rendering unit 102 in the subsequent stage to perform the following processes (1) and (2) on the acoustic signals of the foreign-language-dubbed version.
(1) During the mixing process, time-varying panning information can be applied to the direct-wave component.
(2) It is possible to change the intensity and impression of reverberation by adding gain correction or a delay to the impulse response of the reverberation component.

### D. Example Application (1)

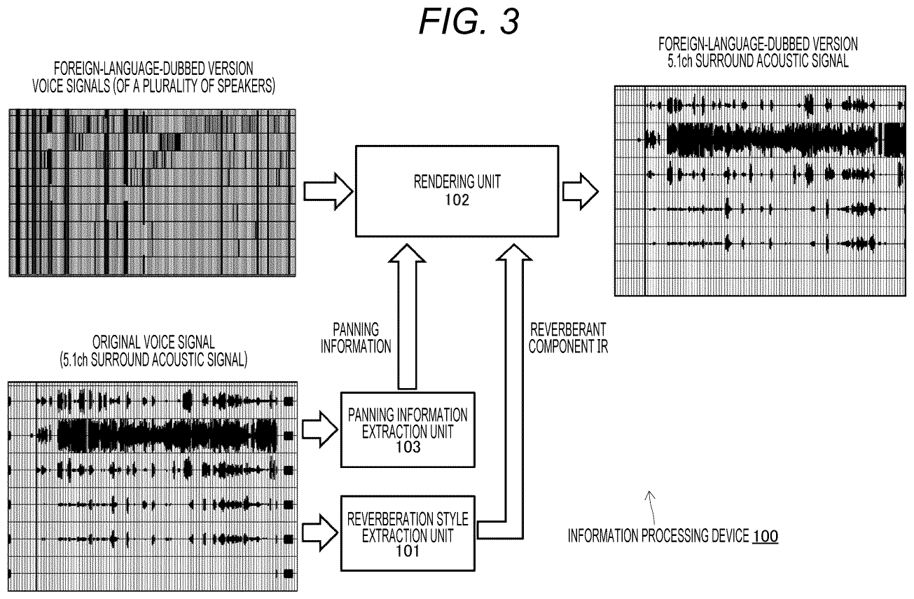

FIG. 3 illustrates an example configuration of an information processing device 100 that performs automatic dubbing, using the configurations illustrated in FIGS. 1 and 2 as the bases. The information processing device 100 illustrated in the drawing includes a reverberation style extraction unit 101, a rendering unit 102, and a panning information extraction unit 103.

The reverberation style extraction unit 101 is formed with a DNN model (described above) trained by deep learning so as to separate and extract an impulse response (IR) of a 1ch direct-wave component and an impulse response (IR) of a multi-channel reverberation component from an original multi-channel surround acoustic signal, receives an input of a multi-channel surround acoustic signal such as an original sound source signal of movie content, and separates and extracts a 1ch impulse response (without panning information) corresponding to a direct-wave component and an impulse response of a surround signal corresponding to a reverberation component.

The panning information extraction unit 103 estimates panning information about a dialogue component (direct-wave component) from the original multi-channel surround acoustic signal. The panning information extracts position information about the right and left and the front and back of a sound image. The panning information extraction unit 103 is formed with a DNN trained by deep learning so as to estimate panning information about a dialogue component (direct-wave components) from an original multi-channel surround acoustic signal. Such a DNN can be trained using a data set including acoustic signals and panning information about direct-wave components of enormous amounts of movie content in the past, for example. Also, it is possible to construct a data set using clean audio signals and impulse responses generated by an acoustic simulator.

The rendering unit 102 receives inputs of a foreign-language dubbed-in voice signal, the respective impulse responses of the direct-wave component (without panning information) and the reverberation component extracted from the original surround acoustic signal by the reverberation style extraction unit 101, and the panning information extracted from the original surround acoustic signal by the panning information extraction unit 103. In the drawing, the foreign-language dubbed-in voice signal to be input to the rendering unit 102 includes a voice signal of each speaker of a plurality of speakers. The rendering unit 102 then performs panning of the foreign-language dubbed-in voice signal on the basis of the panning information extracted by the panning information extraction unit 103, and automatically adds an effect such as reverberation to the foreign-language dubbed-in voice signal on the basis of the respective impulse responses of the direct-wave component and the reverberation component, to generate a multi-channel surround acoustic signal of a foreign-language-dubbed version.

### E. Example Application (2)

Although an embodiment and an example application for extracting a reverberation style from a multi-channel acoustic signal have been described above, the present disclosure can be further applied to a monophonic acoustic signal.

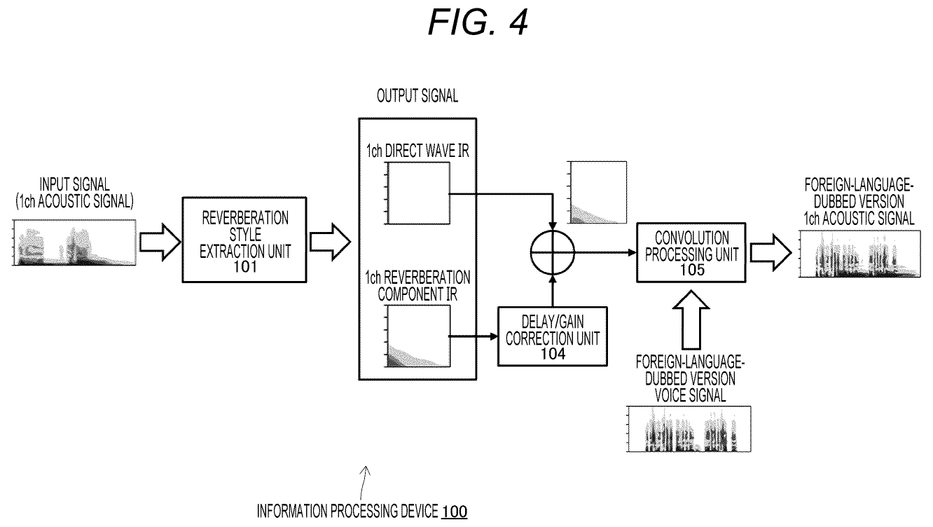

FIG. 4 illustrates an example configuration of an information processing device 100 that extracts a reverberation style from a monophonic acoustic signal, and automatically adds reverberation and an effect to a dubbed-in voice in a foreign language. The information processing device 100 illustrated in the drawing includes a reverberation style extraction unit 101, a delay/gain correction unit 104, and a convolution processing unit 105.

The reverberation style extraction unit 101 separates and extracts a 1ch impulse response (IR) corresponding to a direct-wave component and a 1ch reverberation component impulse response (IR) corresponding to a reverberation component from an original monophonic (1ch) acoustic signal. The reverberation style extraction unit 101 can be formed with a DNN model (described above) trained by deep learning so as to separate and extract an impulse response (IR) of a 1ch direct-wave component and an impulse response (IR) of a multi-channel reverberation component from a multi-channel surround acoustic signal in manner similar to that described above.

The delay/gain correction unit 104 adds a delay to the impulse response of the 1ch reverberation component extracted by the reverberation style extraction unit 101, and performs gain correction thereon. The impulse response of the 1ch direct-wave component extracted by the reverberation style extraction unit 101 and the impulse response of the 1ch reverberation component subjected to delay and gain correction are added up, and are then input to the convolution processing unit 105.

The convolution processing unit 105 convolves the 1ch impulse responses of the direct-wave component and the reverberation component described above into a foreign-language dubbed-in voice signal, to generate a 1ch foreign-language-dubbed version acoustic signal.

In a case where a DNN trained for surround signals as described above is also used in processing monophonic signals, there is an advantage in that there is no need to train a plurality of DNN models. Furthermore, although FIG. 4 illustrates an example application to processing of monophonic signals, a DNN trained for 5.1ch surround signals can also be applied to processing of stereo signals or 3ch signals of L/C/R.

### F. Example Application to Movie Content Creation

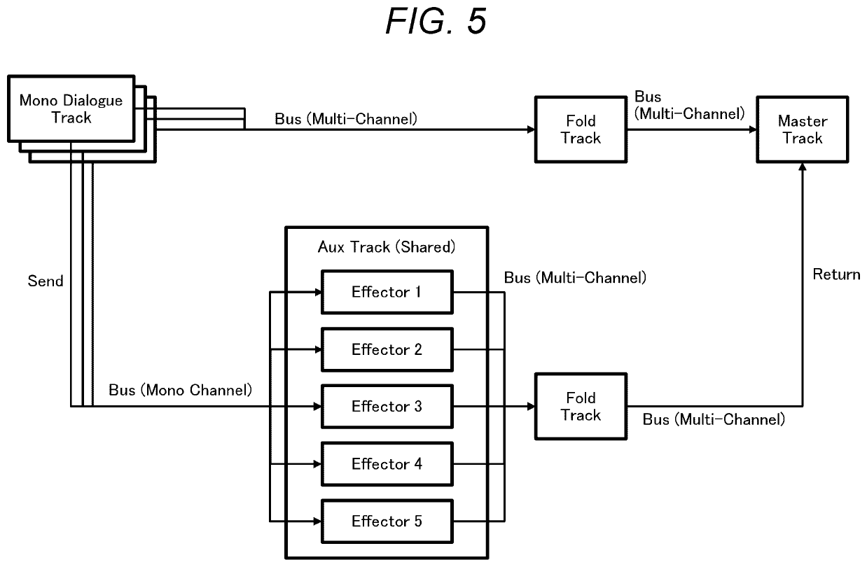

FIG. 5 illustrates an example of a functional configuration for editing an effect to be added to acoustic signals in movie content creation. In the example illustrated in the drawing, a plurality of 1ch dialogue tracks (Mono Dialogue Tracks) is connected in parallel to effectors in a send-return system. Each dialogue track is a voice signal of a foreign-language-dubbed version. A total of five effectors, which are effectors 1 to 5, are included, and an auxiliary track (Aux Track) for each effector is shared by the plurality of dialogue tracks.

An equalizer (EQ), reverberation (Reverb), panning, a gain, and the like are set for each auxiliary track for the effectors 1 to 5. Reverberation and panning can be extracted from an original multi-channel acoustic signal with the trained DNN (reverberation style extraction unit 101) described above.

Each dialogue track is passed on to the auxiliary track via the send (mono channel) of the send-return system. Which effector each dialogue track is to use is determined by designating mute control.

In each dialogue and each effect track, panning information is set, a multi-channeled signal is input to a fold track (Fold Track), and is passed on to the master track as the return of the send-return system.

Meanwhile, a signal (Bus) obtained by multi-channelizing a plurality of dialogue tracks is passed on to the master track not via any effector (auxiliary track) but via the fold track on the other side.

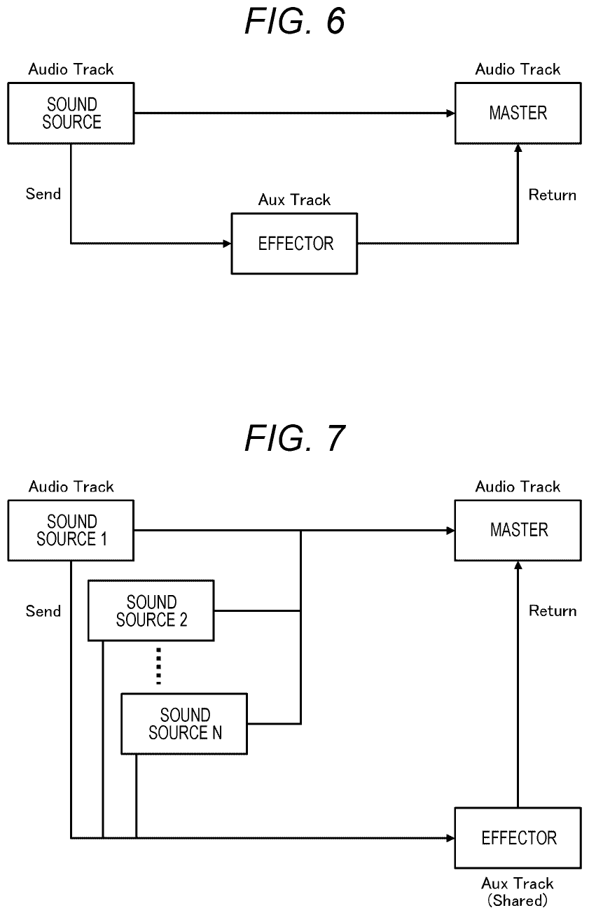

FIG. 6 illustrates an example configuration of the send-return in a case where the number of sound sources is one. The auxiliary track for the effector is connected in parallel to the audio track from the sound source to the master by the send-return system. The sound source is a foreign-language dubbed-in voice, for example, and the effector corresponds to the rendering unit 103 that mixes the respective impulse responses of the direct-wave component and the reverberation components extracted by the reverberation extraction unit 101 with the foreign-language dubbed-in voice signal.

FIG. 7 illustrates an example configuration of the send-return in a case where the number of sound sources is plural. While the audio track of each sound source is directed to the master, the effector is connected in parallel by an auxiliary track. Each sound source is passed on to the auxiliary track for the effector via the send of the send-return system, and is passed on to the master via the return. The respective sound sources are the respective foreign-language dubbed-in voices of a plurality of speakers, for example, and the effector corresponds to the rendering unit 103 that mixes the respective impulse responses of the direct-wave components and the reverberation components extracted by the reverberation extraction unit 101 with the foreign-language dubbed-in voice signals.

As the auxiliary track for applying an effect to a plurality of sound sources (audio tracks) 1 to N is shared as illustrated in FIG. 7, the same effect (reverberation, an equalizer, or the like) can be applied to the respective sound sources.

### G. Input to DNN

A multi-channel surround acoustic signal to be input to a DNN that is used for the reverberation style extraction unit 101 of the information processing device 100 differs from a monophonic signal in that the position of the sound source (which is the panning information) changes with time.

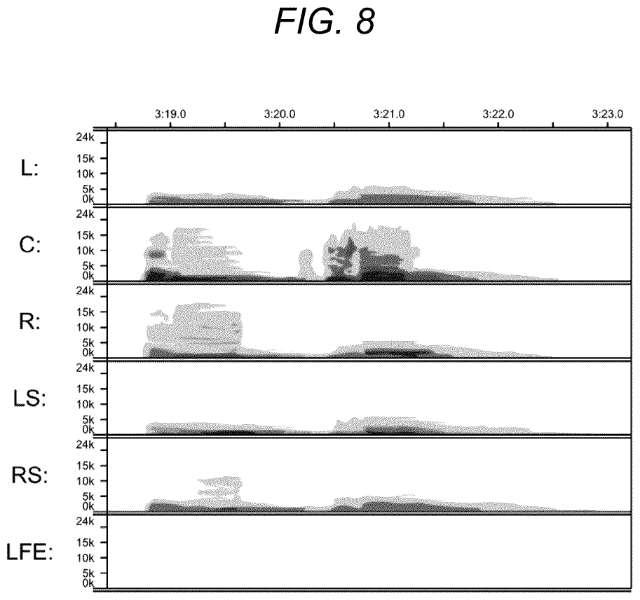

FIG. 8 illustrates an example of the waveform of a 5.1ch surround signal. This chart shows temporal changes in the respective channels of L, C, R, LS, RS, and LFE of the subwoofer. The horizontal axis is the time axis. In the former half of the chart, the position of the sound source is between Center and Right, but, in the latter half, the position of the sound source is at Center. In contrast, reverberation is applied to each channel.

In a case where a multi-channel surround acoustic signal as illustrated in FIG. 8 is input to the DNN used for the reverberation style extraction unit 101, it is possible to effectively extract reverberation information and temporally changing panning information, taking advantage of correlation information between the channels.

### H. Configuration of Information Processing Device

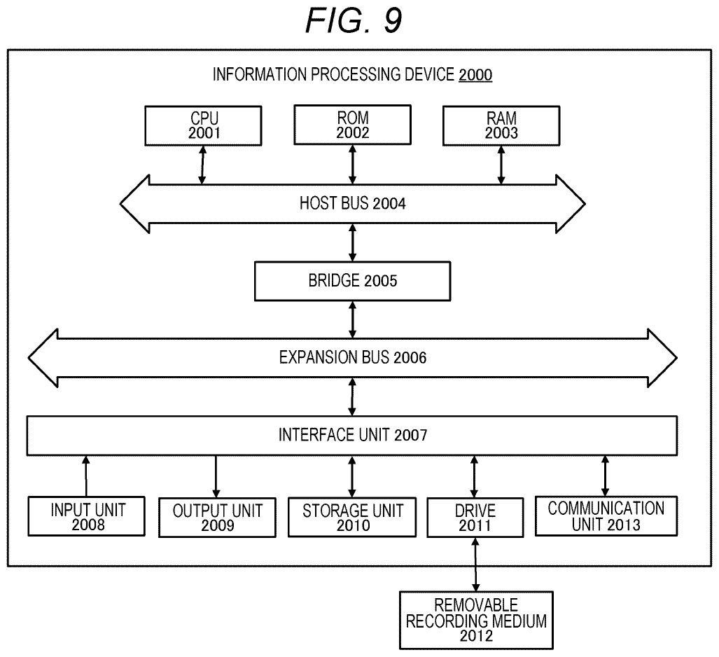

In this Chapter H, an information processing device that is used for processing acoustic signals in the present disclosure is described. FIG. 9 illustrates an example configuration of an information processing device 2000 that is used for producing a foreign-language-dubbed version of movie content, and performs a process of automatically adding an effect such as the reverberation of foreign-language-dubbed signals on the basis of the present disclosure.

The information processing device 2000 illustrated in FIG. 9 includes a central processing unit (CPU) 2001, a read only memory (ROM) 2002, a random access memory (RAM) 2003, a host bus 2004, a bridge 2005, an expansion bus 2006, an interface unit 2007, an input unit 2008, an output unit 2009, a storage unit 2010, a drive 2011, and a communication unit 2013.

The CPU 2001 controls entire operations of the information processing device 2000 in accordance with various programs. The ROM 2002 stores, in a nonvolatile manner, programs (such as a basic input/output system) and computation parameters to be used by the CPU 2001. The RAM 2003 is used to load programs to be used in execution by the CPU 2001 and temporarily store parameters such as work data that appropriately changes during program execution. Examples of the programs to be loaded into the RAM 2003 and executed by the CPU 2001 include various application programs, an operating system (OS), and the like.

The CPU 2001, the ROM 2002, and the RAM 2003 are interconnected by the host bus 2004 formed with a CPU bus or the like. Further, the CPU 2001 operates in conjunction with the ROM 2002 and the RAM 2003 to execute various application programs under an execution environment provided by the OS, and thus, can provide various functions and services. In a case where the information processing device 2000 is a PC, the OS is Windows (registered trademark) of Microsoft Corporation or Unix (registered trademark), for example. Furthermore, the application programs include an application for performing a process of extracting the respective impulse responses of a direct-wave component and a reverberation component from an original acoustic signal, and a process of mixing the respective impulse responses of the direct-wave component and the reverberation component with a voice signal for a foreign-language dubbed-in voice.

The host bus 2004 is connected to the expansion bus 2006 via the bridge 2005. The expansion bus 2006 is a peripheral component interconnect (PCI) bus or PCI Express, for example, and the bridge 2005 is based on the PCI standard. Note that the information processing device 2000 does not necessarily have a configuration in which circuit components are separated by the host bus 2004, the bridge 2005, and the expansion bus 2006, and may be designed in such a manner that almost all circuit components are interconnected by a single bus (not shown).

The interface unit 2007 connects peripheral devices such as the input unit 2008, the output unit 2009, the storage unit 2010, the drive 2011, and the communication unit 2013, in accordance with the standard of the expansion bus 2006. Note that all of the peripheral devices shown in FIG. 9 are not necessarily essential, and the information processing device 2000 may further include a peripheral device not shown in the drawing. Furthermore, the peripheral devices may be contained in the main unit of the information processing device 2000, or some of the peripheral devices may be externally connected to the main unit of the information processing device 2000.

The input unit 2008 is formed with an input control circuit or the like that generates an input signal on the basis of an input from a user, and outputs the input signal to the CPU 2001. In a case where the information processing device 2000 is a personal computer, the input unit 2008 may include a keyboard, a mouse, and a touch panel, and may further include a camera and a microphone. Meanwhile, the output unit 2009 includes a display device such as a liquid crystal display (LCD) device, an organic electro-luminescence (EL) display device, or a light emitting diode (LED), for example.

The storage unit 2010 stores programs (applications, the OS, and the like) to be executed by the CPU 2001, and files of various kinds of data and the like. Although the storage unit 2010 is formed with a mass storage device such as a solid state drive (SSD) or a hard disk drive (HDD), for example, it may include an external storage device.

A removable storage medium 2012 is a storage medium formed with a cartridge-type storage medium like a micro-SD card, for example. The drive 2011 performs reading and writing operations on the removable storage medium 113 loaded therein. The drive 2011 outputs data read from the removable recording medium 2012 to the RAM 2003 and the storage unit 2010, and writes data in the RAM 2003 and the storage unit 2010 into the removable recording medium 2012.

The communication unit 2013 is a device that performs wireless communication if Wi-Fi (registered trademark), Bluetooth (registered trademark), or a cellular communication network such as 4G or 5G. Furthermore, the communication unit 2013 also include a terminal such as a universal serial bus (USB) or a high-definition multimedia interface (HDMI: registered trademark), and may further include a function of performing HDMI (registered trademark) communication with a USB device such as a scanner or a printer, a display, or the like.

Although a personal computer (PC) is considered as the information processing device 2000, the number of PCs is not necessarily one, and the information processing device 100 illustrated in FIGS. 1 to 4 may be implemented with two or more PCs in a distributing manner, or the PC may be designed to perform processing for producing foreign-language dubbed-in voice signals of movie content and the like.

### INDUSTRIAL APPLICABILITY

The present disclosure has been described in detail, with reference to the specific embodiment. However, the present disclosure should not be construed as being limited to the above-described embodiment, and those skilled in the art obviously can make modifications and substitutions of the embodiment without departing from the gist of the present disclosure. Additionally, the effects described in the present specification are merely an example, and the effects to be brought about by the embodiment of the present disclosure are not restrictive and may include some additional effects that are not mentioned herein.

The present disclosure can be applied to a system for producing a foreign-language-dubbed version of content and mixing content such as movies, automated dialogue replacement (ADR), and the like.

Although the present disclosure has been described by way of examples, the details disclosed in the present specification should not be interpreted in a limited manner. To determine the gist of the present disclosure, the claims should be taken into consideration.

The series of processes described in the present specification can be performed by hardware, software, or a configuration in which hardware and software are combined. In a case where a process is performed by software, a program in which a processing sequence related to implementation of the present disclosure is written is installed in a memory incorporated in dedicated hardware in a computer, and is then executed. It is also possible to install a program in a general-purpose computer capable of performing various kinds of processing, and cause the computer to perform the processing related to implementation of the present disclosure.

The program can be stored beforehand in a recording medium provided in the computer, such as an HDD, an SSD, or a ROM, for example. Alternatively, the program can be temporarily or permanently stored in a removable recording medium such as a flexible disk, a compact disc read only memory (CD-ROM), a magneto optical (MO) disk, a digital versatile disc (DVD), a Blu-ray Disc (BD) (registered trademark), a magnetic disk, or a universal serial bus (USB) memory. With such a removable recording medium, it is possible to provide the program related to implementation of the present disclosure as so-called packaged software.

Also, the program may be transferred from a download site to a computer in a wireless or wired manner via a network such as a wide area network (WAN) typified by a cellular network, a local area network (LAN), or the Internet. The computer can receive the program transferred in such a manner, and install the program in a mass storage device such as an HDD or an SSD in the computer.

Note that the present disclosure may also have the following configurations.
(1) An information processing device including a reverberation extraction unit that receives an input of an acoustic signal, and separates and extracts a 1ch impulse response corresponding to a direct-wave component and an impulse response of a reverberation component.
(2) The information processing device according to (1),
   in which the reverberation extraction unit separates and extracts the respective impulse responses of the direct-wave component and the reverberation component from the acoustic signal, using a trained model that has been trained to estimate a 1ch impulse response corresponding to a direct-wave component and an impulse response of a surround signal corresponding to a reverberation component from a multi-channel acoustic signal.
(3) The information processing device according to (1) or (2), further including
   a rendering unit that mixes a dubbing voice signal corresponding to a voice signal included in the acoustic signal with the respective impulse responses of the direct-wave component and the reverberation component extracted by the reverberation extraction unit, to generate an acoustic signal of a dubbed version.
(4) The information processing device according to (3), in which
   the rendering unit applies time-varying panning information to the direct-wave component during mixing processing.
(5) The information processing device according to (3) or (4),
   in which the rendering unit changes intensity and impression of reverberation by adding gain correction or a delay to the impulse response of the reverberation component.
(6) The information processing device according to any one of (1) to (5),
   in which the reverberation extraction unit receives an input of a multi-channel acoustic signal, and extracts a 1ch impulse response corresponding to a direct-wave component and an impulse response of a surround signal corresponding to a reverberation component, and
   the information processing device further includes a panning information extraction unit that extracts panning information about a dialogue component (direct-wave component) from the multi-channel acoustic signal.
(7) The information processing device according to (6),
   in which the panning information extraction unit extracts the panning information about the dialogue component included in the multi-channel acoustic signal, using a trained model that has been trained to estimate panning information about a dialogue component from a multi-channel acoustic signal.
(8) The information processing device according to (6) or (7), further including
   a rendering unit that performs panning on a dubbing voice signal corresponding to a voice signal included in the acoustic signal on the basis of the panning information extracted by the panning information extraction unit, and mixes the dubbing voice signal with the respective impulse responses of the direct-wave component and the reverberation component extracted by the reverberation extraction unit, to generate an acoustic signal of a dubbed version.
(9) The information processing device according to (2),
   in which the reverberation extraction unit separates and extracts a 1ch impulse response corresponding to a direct-wave component and an impulse response of a 1ch reverberation component from a 1ch acoustic signal.
(10) The information processing device according to (9), further including:
   a delay/gain correction unit that adds a delay to and performs gain correction on the impulse response of the 1ch reverberation component extracted by the reverberation extraction unit; and
   a convolution processing unit that convolutes the 1ch reverberation component after performing the delay addition to and the gain correction on the 1ch impulse response corresponding to the direct-wave component into a dubbing voice signal corresponding to a voice signal included in the acoustic signal.
(11) An information processing method including:
   a reverberation extraction step of receiving an input of an acoustic signal, and separating and extracting a 1ch impulse response corresponding to a direct-wave component and an impulse response of a reverberation component; and
   a rendering step of mixing a dubbing voice signal corresponding to a voice signal included in the acoustic signal with the respective impulse responses of the direct-wave component and the reverberation component extracted in the reverberation extraction step, to generate an acoustic signal of a dubbed version.
(12) A computer program written in a computer-readable format to cause a computer to function as:
   a reverberation extraction unit that receives an input of an acoustic signal, and separates and extracts a 1ch impulse response corresponding to a direct-wave component and an impulse response of a reverberation component; and
   a rendering unit that mixes a dubbing voice signal corresponding to a voice signal included in the acoustic signal with the respective impulse responses of the direct-wave component and the reverberation component extracted by the reverberation extraction unit, and generate an acoustic signal of a dubbed version.

### REFERENCE SIGNS LIST

100 Information processing device
101 Reverberation style extraction unit
102 Rendering unit
103 Panning information extraction unit
104 Delay/gain correction unit
105 Convolution processing unit
2000 Information processing device
2001 CPU
2002 ROM
2003 RAM
2004 Host bus
2005 Bridge
2006 Expansion bus
2007 Interface unit
2008 Input unit
2009 Output unit
2010 Storage unit
2011 Drive
2012 Removable recording medium
2013 Communication unit

1. An information processing device comprising a reverberation extraction unit that receives an input of an acoustic signal, and separates and extracts a 1ch impulse response corresponding to a direct-wave component and an impulse response of a reverberation component.

2. The information processing device according to claim 1,
wherein the reverberation extraction unit separates and extracts the respective impulse responses of the direct-wave component and the reverberation component from the acoustic signal, using a trained model that has been trained to estimate a 1ch impulse response corresponding to a direct-wave component and an impulse response of a surround signal corresponding to a reverberation component from a multi-channel acoustic signal.

3. The information processing device according to claim 1, further comprising
a rendering unit that mixes a dubbing voice signal corresponding to a voice signal included in the acoustic signal with the respective impulse responses of the direct-wave component and the reverberation component extracted by the reverberation extraction unit, to generate an acoustic signal of a dubbed version.

4. The information processing device according to claim 3,
wherein the rendering unit applies time-varying panning information to the direct-wave component during mixing processing.

5. The information processing device according to claim 3,
wherein the rendering unit changes intensity and impression of reverberation by adding gain correction or a delay to the impulse response of the reverberation component.

6. The information processing device according to claim 1,
wherein the reverberation extraction unit receives an input of a multi-channel acoustic signal, and extracts a 1ch impulse response corresponding to a direct-wave component and an impulse response of a surround signal corresponding to a reverberation component, and
the information processing device further comprises a panning information extraction unit that extracts panning information about a dialogue component (direct-wave component) from the multi-channel acoustic signal.

7. The information processing device according to claim 6, wherein
the panning information extraction unit extracts the panning information about the dialogue component included in the multi-channel acoustic signal, using a trained model that has been trained to estimate panning information about a dialogue component from a multi-channel acoustic signal.

8. The information processing device according to claim 6, further comprising
a rendering unit that performs panning on a dubbing voice signal corresponding to a voice signal included in the acoustic signal on a basis of the panning information extracted by the panning information extraction unit, and mixes the dubbing voice signal with the respective impulse responses of the direct-wave component and the reverberation component extracted by the reverberation extraction unit, to generate an acoustic signal of a dubbed version.

9. The information processing device according to claim 2,
wherein the reverberation extraction unit separates and extracts a 1ch impulse response corresponding to a direct-wave component and an impulse response of a 1ch reverberation component from a 1ch acoustic signal.

10. The information processing device according to claim 9, further comprising:
a delay/gain correction unit that adds a delay to and performs gain correction on the impulse response of the 1ch reverberation component extracted by the reverberation extraction unit; and
a convolution processing unit that convolutes the 1ch reverberation component after performing the delay addition to and the gain correction on the 1ch impulse response corresponding to the direct-wave component into a dubbing voice signal corresponding to a voice signal included in the acoustic signal.

11. An information processing method comprising:
a reverberation extraction step of receiving an input of an acoustic signal, and separating and extracting a 1ch impulse response corresponding to a direct-wave component and an impulse response of a reverberation component; and
a rendering step of mixing a dubbing voice signal corresponding to a voice signal included in the acoustic signal with the respective impulse responses of the direct-wave component and the reverberation component extracted in the reverberation extraction step, to generate an acoustic signal of a dubbed version.

12. A computer program written in a computer-readable format to cause a computer to function as:
a reverberation extraction unit that receives an input of an acoustic signal, and separates and extracts a 1ch impulse response corresponding to a direct-wave component and an impulse response of a reverberation component; and
a rendering unit that mixes a dubbing voice signal corresponding to a voice signal included in the acoustic signal with the respective impulse responses of the direct-wave component and the reverberation component extracted by the reverberation extraction unit, and generate an acoustic signal of a dubbed version.
